(19) United States
(12) Patent Application Publication
(10) Pub. No.: US 2020/0198312 A1
(43) Pub. Date: Jun. 25, 2020

(54) LOW GLOSS SHEET AND MATTE PRODUCT FORMED THEREFROM

(71) Applicant: Far Eastern New Century Corporation, Taipei (TW)

(72) Inventors: Kuan-Liang Wei, Taoyuan City (TW); Tsang-Pin Chen, Taoyuan City (TW)

(21) Appl. No.: 16/558,435

(22) Filed: Sep. 3, 2019

(30) Foreign Application Priority Data
Dec. 20, 2018 (TW) 107146234

(51) Int. Cl. B32B 27/36; B32B 27/14; B32B 27/18

(52) U.S. Cl. CPC B32B 27/36; B32B 27/14; B32B 27/18; C08L 67/02; B32B 2250/02; B32B 2250/03; B32B 2307/408

(57) ABSTRACT

The present disclosure provides a low gloss sheet and a matte product prepared therefrom. The low gloss sheet includes a substrate and a low gloss layer disposed thereon. The low gloss layer includes polyester and a matting agent. A weight percentage of the matting agent is 4 wt % to 10 wt % based on the total weight of the low gloss layer. The matting agent includes a plurality of first particles and a plurality of second particles. An average particle diameter (d₅₀) of the first particles and the second particles is 8 to 10 μm and 3 to 6 μm respectively. An oil absorption of the second particles is 30 to 100 ml/100 g. The matte product is prepared from the low gloss sheet by a forming technique.

### CROSS-REFERENCE TO RELATED APPLICATION

This application claims priority to Taiwan Application Serial Number 107146234, filed Dec. 20, 2018, which is herein incorporated by reference.

### BACKGROUND

### Field of Invention

The present disclosure relates to a low gloss sheet and a matte product formed therefrom.

### Description of Related Art

Polyester sheets are widely used in various industries. For example, polyester sheets may serve as packaging material for products. Packaging materials may exhibit an exquisite appearance if the surface gloss is low. However, conventional polyester sheets usually have a high surface gloss. Accordingly, there is a need for a polyester sheet having a low surface gloss, especially a polyester sheet having a low surface gloss after heating and stretching processes.

### SUMMARY

The present disclosure provides a low gloss sheet. The low gloss sheet includes a substrate and a low gloss layer disposed thereon. The low gloss layer includes polyester and a matting agent. The matting agent has a weight percentage ranged from 4 wt % to 10 wt % based on the total weight of the low gloss layer. The matting agent includes a plurality of first particles and a plurality of second particles. The first particles have an average particle diameter (d₅₀) of 8 μm to 10 μm, and the second particles have an average particle diameter (d₅₀) of 3 μm to 6 μm. An oil absorption of the second particles ranges from 30 ml/100 g to 100 ml/100 g.

In some embodiments of the present disclosure, an oil absorption of the first particles ranges from 10 ml/100 g to 40 ml/100 g.

In some embodiments of the present disclosure, an oil absorption of the second particles ranges from 40 ml/100 g to 60 ml/100 g.

In some embodiments of the present disclosure, the first particles include talcum powder, calcium carbonate powder, or a combination thereof.

In some embodiments of the present disclosure, the second particles include talcum powder.

In some embodiments of the present disclosure, the weight percentage of the matting agent ranges from 7 wt % to 9 wt % based on the total weight of the low gloss layer.

In some embodiments of the present disclosure, a weight percentage of the second particles ranges from 1 wt % to 6 wt % based on the total weight of the low gloss layer.

In some embodiments of the present disclosure, a weight percentage of the second particles ranges from 4 wt % to 6 wt % based on the total weight of the low gloss layer.

In some embodiments of the present disclosure, the substrate comprises polyester.

In some embodiments of the present disclosure, a thickness of the low gloss layer ranges from 40 to 70 μm.

In some embodiments of the present disclosure, a thickness of the low gloss layer ranges from 50 to 60 μm.

In some embodiments of the present disclosure, a gloss of the low gloss layer is less than or equal to 65 GU at a measuring angle of 60°.

The present disclosure also provides a matte product manufactured from the low gloss sheet by a forming technique.

In some embodiments of the present disclosure, a gloss of the matte product is less than or equal to 30 GU at a measuring angle of 60°.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion. Like reference numerals denote like features throughout specification and drawings.

FIG. 1 is a schematic sectional view of a low gloss sheet according to one embodiment of the present disclosure.

FIG. 2 is a schematic sectional view of a low gloss sheet according to another embodiment of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting.

The following examples are provided to illustrate certain aspects of the present disclosure and to aid those of skill in the art in practicing this disclosure. These examples are in no way to be considered to limit the scope of the disclosure in any manner.

It is understood that although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

Reference is now be made in detail to the embodiments of the present disclosure, examples of which are illustrated in the accompanying drawings. Wherever possible, the same reference numbers are used in the drawings and the description to refer to the same or like parts.

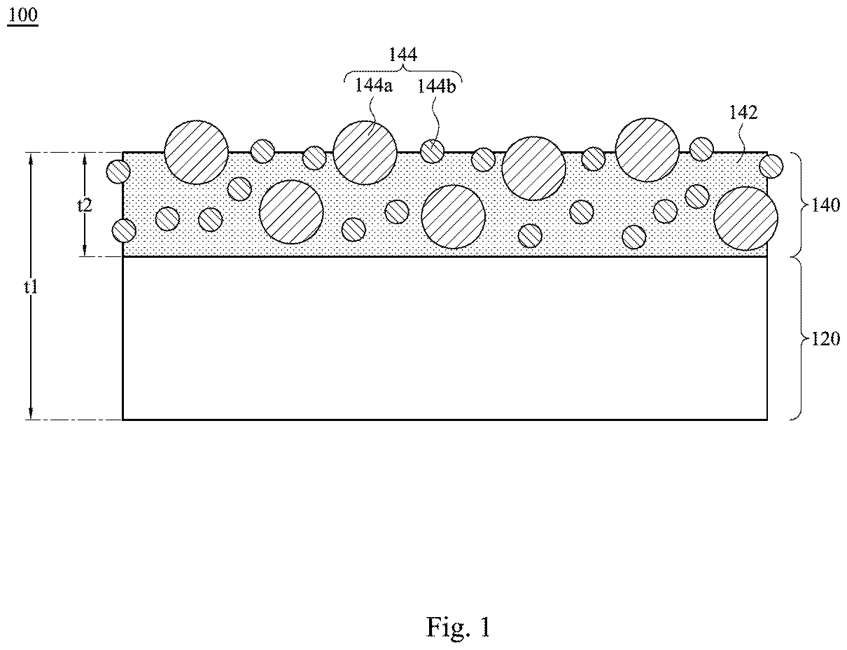

FIG. 1 is a schematic sectional view of a low gloss sheet 100 according to one embodiment of the present disclosure. The low gloss sheet 100 includes a substrate 120 and a low gloss layer 140. In some embodiments, the substrate 120 includes polyester, such as polyethylene terephthalate (PET), polybutylene terephthalate (PBT) or the like, but is not limited thereto. In some other embodiments, the polyester may also include a copolymer of polyesters or a mixture of polyesters.

The low gloss layer 140 is disposed on the substrate 120. The low gloss layer 140 is also referred to as a “matted layer.” The low gloss layer 140 includes a polyester 142 and a matting agent 144. In one embodiment, the polyester 142 may be such as polyethylene terephthalate (PET), polybutylene terephthalate (PBT) or the like, but is not limited thereto. In some other embodiments, the polyester 142 may include a copolymer of polyesters or a mixture of polyesters.

The matting agent 144 includes a plurality of first particles 144a and a plurality of second particles 144b. An average particle diameter d₅₀ of the first particles 144a ranges from 8 μm to 10 μm, such as 8.3 μm, 8.6 μm, 8.8 μm, 9.2 μm, 9.6 μm, or 9.8 μm. An average particle diameter d₅₀ of the second particles 144b ranges from 3 to 6 μm, such as 3.3 μm, 3.6 μm, 3.9 μm, 4.2 μm, 4.6 μm, 4.8 μm, 5.2 μm, 5.6 μm, or 5.8 μm.

In some embodiments, an oil absorption of the first particles 144a ranges from 10 ml/100 g to 40 ml/100 g, preferably from 12 ml/100 g to 35 ml/100 g, such as 15 ml/100 g, 20 ml/100 g, 25 ml/100 g, or 30 ml/100 g. In some embodiments, the oil absorption of the second particles 144b ranges from 30 ml/100 g to 100 ml/100 g, preferably from 35 ml/100 g to 80 ml/100 g, more preferably from 40 ml/100 g to 60 ml/100 g, such as 45 ml/100 g, 50 ml/100 g, or 55 ml/100 g.

In some embodiments, the first particles 144a include talcum powder, calcium carbonate powder or a combination thereof, and the second particles 144b include talcum powder. It is noted that the talcum powder of the first particles 144a and the talcum powder of the second particles 144 may have different average particle diameters d₅₀. Specifically, the average particle diameter d₅₀ of the talcum powder of the first particles 144a may range from 8 μm to 10 μm, and an average particle diameter d₅₀ of the talcum powder of the second particles 144b may range from 3 μm to 6 μm.

It is noted that the first particles 144a and the second particles 144b are both necessary components of the matting agent 144 for certain technical effects in the present disclosure. If the matting agent 144 includes only the first particles 144a, the surface of the low gloss layer 140 will exhibit a noticeable graininess, thereby reducing the aesthetics of the low gloss layer 140. If the matting agent 144 includes only the second particles 144b, the gloss of the low gloss layer 140 may remain high, and thereby the appearance of the low gloss layer 140 is less exquisite.

A weight percentage of the matting agent 144 may range from 4 wt % to 10 wt %, such as 5 wt %, 6 wt %, or 8 wt %, based on the total weight of the low gloss layer 140. Preferably, the weight percentage of the matting agent 144 may range from 7 wt % to 9 wt %, based on the total weight of the low gloss layer 140. It is noted that if the weight percentage of the matting agent 144 is greater than 10 wt %, the impact strength of the low gloss sheet 100, which is subsequently formed, may be reduced, thereby fails to meet the common requirements on using polyester sheet for packaging. If the weight percentage of the matting agent 144 is less than 4 wt %, the gloss of the low gloss layer 140 may remain high, and thereby the appearance of the low gloss layer 140 is less exquisite. In some embodiments, a weight percentage of the first particles 144a may range from 1 wt % to 5 wt %, and a weight percentage of the second particles 144b may range from 2 wt % to 7wt %, based on the total weight of the low gloss layer 140. In some embodiments of the present disclosure, the weight percentage of the second particles 144b may range from 1 wt % to 6 wt % based on the total weight of the low gloss layer 140.

In one preferred embodiment, the weight percentage of the matting agent 144 ranges from 7 wt % to 9 wt %, in which the weight percentage of the first particles 144a and the second particles 144b ranges from 1 wt % to 5 wt % and 4 wt % to 6 wt % respectively, based on the total weight of the low gloss layer 140. It is noted that the gloss of the low gloss layer 140 is further decreased in this preferred embodiment.

In some embodiments, a thickness t1 of the low gloss sheet 100 may range from 500 to 1400 μm, such as 600 μm, 800 μm, 1000 μm, or 1200 μm, and a thickness t2 of the low gloss layer 140 may range from 40 to 70 μm, preferably from 50 to 60 μm, such as 52 μm, 54 μm, 56 μm, or 58 μm. In some embodiments, a gloss of the low gloss layer 140 is less than or equal to 65 GU at a measuring angle of 60°.

The present disclosure also provides a matte product. The matte product is produced from the low gloss sheet 100 by a forming process. In some embodiments, the forming process includes a stretching process, such as a uniaxial stretching process or a biaxial stretching process. In one example, a stretch ratio of the stretching process ranges from about 2 to 4, such as 2.5, 3, or 3.5. In some embodiments, a gloss of the matte product is less than or equal to 30 GU at a measuring angle of 60°.

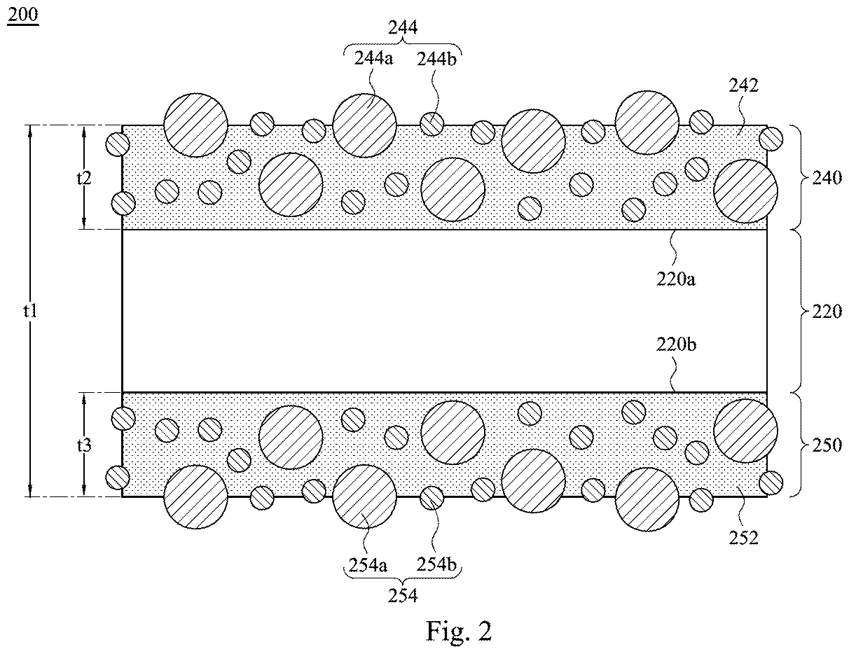

FIG. 2 is a schematic sectional view of a low gloss sheet 200 according to another embodiment of the present disclosure. The low gloss sheet 200 includes a substrate 220, a first low gloss layer 240, and a second low gloss layer 250. The first low gloss layer 240 is disposed on a first surface 220a of the substrate 220. The second low gloss layer 250 is disposed on a second surface 220b of the substrate 220. The substrate 220 has the same or similar materials and properties as the aforementioned substrate 120, and therefore is not repeated herein.

The first low gloss layer 240 has the same or similar materials and properties as the low gloss layer 140, which has been described in the foregoing with respect to FIG. 1. Briefly, the first low gloss layer 240 includes polyester 242 and a matting agent 244. The matting agent 244 includes a plurality of first particles 244a and a plurality of second particles 244b. The polyester 242, the first particles 244a and the second particles 244b of the matting agent 244 has the same or similar materials and properties with the aforementioned polyester 142, first particles 144a and second particles 144b of the matting agent 144 respectively, and therefore are not repeated herein.

The second low gloss layer 250 is disposed on the second surface 220b of the substrate 220. The second low gloss layer 250 is also referred to as a “second matted layer.” The second low gloss layer 250 may include polyester 252 and a matting agent 254. The polyester 252 has the same or similar materials and properties with the aforementioned polyester 142, and therefore are not repeated herein. It is noted that the material and properties of the polyester 252 and the polyester 242 may be the same or different.

The matting agent 254 includes a plurality of third particles 254a and a plurality of fourth particles 254b. The materials and properties of the matting agent 254 may be the same with or similar to the aforementioned matting agent 144, and therefore are not repeated herein. It is noted that the material and properties of the first particles 244a and the third particles 254a may be the same or different. In addition, the material and properties of the second particles 244b and the fourth particles 254b may be the same or different.

On the other hand, the weight percentage of the first particles 244a in the first low gloss layer 240 and the weight percentage of the third particles 254a in the second low gloss layer 250 may be the same or different. In addition, the weight percentage of the second particles 244b in the first low gloss layer 240 and the weight percentage of the fourth particles 254b in the second low gloss layer 250 may be the same or different.

In some embodiments, a thickness t1 of the low gloss sheet 200 may range from 500 μm to 1400 μm, a thickness t2 of the first low gloss layer 240 may range from 40 μm to 70 μm, and a thickness t3 of the second low gloss layer 250 may range from 40 μm to 70 μm. In one embodiment, a gloss of the second low gloss layer 250 is less than or equal to 65 GU at a measuring angle of 60°.

The present disclosure also provides a matte product. The matte product is prepared from the low gloss sheet 200 by a forming process. In some embodiments, the forming process includes a stretching process, such as a uniaxial stretching process or a biaxial stretching process. In one example, a stretch ratio of the stretching process is about 2 to 4, such as 2.5, 3, or 3.5. In some embodiments, a gloss of the matte product is less than or equal to 30 GU at a measuring angle of 60°.

Examples 1-10 and Comparative Examples 1-5 are provided below to demonstrate some properties of exemplary low gloss sheets and matte products prepared therefrom. It should be noted that the following examples are merely illustrative and is not intended to limit the present disclosure.

The matting agent used in Examples 1-10 and Comparative Examples 1-5 includes talcum powder 325H (Model No. 325H, available from Chu Shin Chemical Corporation Limited), talcum powder 1250H (Model No. 1250H, available from Chu Shin Chemical Corporation Limited), talcum powder 3000H (Model 3000H, available from Chu Shin Chemical Corporation Limited), calcium carbonate powder (Model No. TC-1013, available from Lih Hsiang Industrial Corporation Limited), and silicon dioxide powder (Model No. SPERNAT®310, available from Evonik Industries AG). The average particle diameter d₅₀ (unit: μm) and the oil absorption of these matting agents (unit: mL/100 g) are listed in Table 1. The average particle diameter d₅₀ of the matting agent was measured by using a laser diffraction particle size analyzer (Model No. Mastersizer 3000, Malvern Panalytical Ltd.), and the oil absorption of the matting agent was measured in accordance with the standard test method JIS K5101.

TABLE 1

| Material of | calcium | talcum | talcum | talcum | silicon |
|---|---|---|---|---|---|
| matting | carbonate | powder | powder | powder | dioxide |
| agent | powder | 325H | 1250H | 3000H | powder |
| average | 8.5 | 8.8 | 5.8 | 3.8 | 8.5 |
| particle | | | | | |
| diameter | | | | | |
| d₅₀ (μm) | | | | | |
| oil absorption | 13 | 34 | 44 | 50 | 265 |
| (mL/100 g) | | | | | |
| Microscopic | bulk | flake | flake | flake | spherical |
| structure | | | | | |

As shown in Table 1, both calcium carbonate powder and talcum powder 325H has an average particle diameter d₅₀ within the range of 8 μm to 10 μm and an oil absorption within the range of 10 ml/100 g to 40 ml/100 g. On the other hand, both talcum powder 1250H and talcum powder 3000H have an average particle diameter d₅₀ within the range of 3 μm to 6 μm and an oil absorption within the range of 40 ml/100 g to 60 ml/100 g. In addition, the talcum powder 325H, the talcum powder 1250H and the talcum powder 3000H has a flake-like microscopic structure, the calcium carbonate powder has a bulk-like microscopic structure, and the silicon dioxide powder has a spherical microscopic structure.

The preparation of Examples 1-10 and Comparative Examples 1-5 are described below.

### Example 1

Preparation of matting agent masterbatch: the calcium carbonate powder and the talcum powder 3000H were mixed homogeneously to form a mixture. The ratio of the calcium carbonate powder and the talcum powder 3000H are shown in Table 2. The mixture was mixed with PET particles (Model No. CB600H, available from Far Eastern New Century Corporation) by using a twin screw extruder (Model No. PSM50, available from Sine-Alloy Machinery Inc.) to prepare the matting agent masterbatch.

Preparation of low gloss sheet: a low gloss sheet was prepared from the matting agent masterbatch and PET by using a multilayer sheet co-extrusion machine (Model No. CL38879, available from Leader Extrusion Machinery Company Ltd.). The formed low gloss sheet included a substrate and a low gloss layer disposed thereon. The substrate was a PET substrate. The low gloss layer included PET and the matting agent dispersed therein. A total thickness of the low gloss sheet was 600 μm, and a thickness of the low gloss layer was 55 μm. The thicknesses were measured by using a scanning electron microscope (Model No. JSM-6390LV, manufactured by JEOL Ltd., Japan). In addition, Gloss 60° of the low gloss layer was 60 GU, which was measured by using a gloss meter (Model No. GL0030, manufactured by TQC Therminport Quality Control B.V).

Examples 2-10 and Comparative Examples 1-5 were prepared in a manner similar to Example 1, except that the matting agent material and matting agent content in the low gloss layer were altered. The matting agent material and matting agent content of Examples 1-10 and Comparative Examples 1-5 are listed in Table 2.

It is noted that Examples 1-10 and Comparative Examples 1-5 have the following differences. In Examples 1-10, particles with an average particle diameter d₅₀ of 8 μm to 10 μm and particles with an average particle diameter d₅₀ of 3 μm to 6 μm were used for the matting agent includes. No matting agent was used in Comparative Example 1. The matting agent in Comparative Example 2 was silicon dioxide powder (with an average particle diameter d₅₀ of 8.5 μm). The matting agent in Comparative Example 3-4 was calcium carbonate powder (with an average particle diameter d₅₀ of 8.5 μm). The matting agent in Comparative Example 5 was talcum powder 1250H (with an average particle diameter d₅₀ of 5.8 μm).

TABLE 2

| | | material and content (wt %) of matting agent in low gloss layer | | | | | |
|---|---|---|---|---|---|---|---|
| | | calcium | | | | | total matting |
| | | carbonate | talcum | talcum | talcum | silicon dioxide | agent content |
| | | powder | powder | powder | powder | powder | in low gloss |
| Entry | | (TC-1013) | 325H | 1250H | 3000H | (SIPERNAT ®310) | layer (wt %) |
| Examples | 1 | 2 | — | — | 3 | — | 5 |
| | 2 | 3 | — | — | 2 | — | 5 |
| | 3 | 3 | — | — | 3 | — | 6 |
| | 4 | 2 | — | — | 4 | — | 6 |
| | 5 | 2 | — | — | 5 | — | 7 |
| | 6 | 2 | — | 5 | — | — | 7 |
| | 7 | — | 2 | 5 | — | — | 7 |
| | 8 | 2 | 1 | — | 5 | — | 8 |
| | 9 | 2 | 1 | 5 | — | — | 8 |
| | 10 | — | 3 | 5 | — | — | 8 |
| Compara- | 1 | — | — | — | — | — | 0 |
| tive | 2 | — | — | — | — | 2 | 2 |
| Examples | 3 | 2 | — | — | — | — | 2 |
| | 4 | 3 | — | — | — | — | 3 |
| | 5 | — | — | 5 | — | — | 5 |

Next, the low gloss sheet of each Examples 1-10 and Comparative Examples 1-5 were subjected to a biaxial stretching process. Specifically, the low gloss sheet was preheated to become soft. The heating time was 100 seconds, and the heating temperature was 88° C. After that, the low gloss sheet was stretched and prepared into a matte product in a stretch ratio of 2.3 by using a biaxial stretching machine (Model No. KARO IV, manufactured by Brückner Maschinenbau GmbH).

Subsequently, some properties of the matte product of Examples 1-10 and Comparative Examples 1-5 were measured. The properties include Gloss 60° of the low gloss layer of the matte product, tensile modulus (unit: kgf/cm²), tensile strength (unit: kgf/cm²), elongation at break (unit: %), and impact strength (unit: g/mm) of the matte product. The tensile modulus, tensile strength, and elongation at break of the matte product were measured by using a tensile testing machine (Model No. 5900, manufactured by Instron). The impact strength of the matte product was measured by using a drop tower impact system (Model No. CEAST 9350, manufactured by Instron). The results of Examples 1-10 and Comparative Examples 1-5 are listed in Table 3.

In Table 3, the term “Gloss 60° before stretching” refers to the gloss level of the low gloss layer of the low gloss sheet at a measuring angle of 60°. The term “Gloss 60° after stretching” refers to the gloss level of the low gloss layer of the matte product at a measuring angle of 60°. N/A means no data available.

TABLE 3

| | | | | | | Gloss 60° | |
|---|---|---|---|---|---|---|---|
| | | | | elon- | | (GU) | |
| | | tensile | tensile | gation | impact | before | after |
| | | modulus | strength | at break | strength | stretch- | stretch- |
| Entry | | (kgf/cm²) | (kgf/cm²) | (%) | (g/mm) | ing | ing |
| Example | 1 | 24735 | 562 | 439 | 1916 | 60 | 12 |
| | 2 | 24376 | 553 | 422 | 1892 | 53 | 14 |
| | 3 | 24172 | 548 | 442 | 1884 | 50 | 25 |
| | 4 | 27517 | 563 | 423 | 1943 | 45 | 10 |
| | 5 | 25607 | 527 | 474 | 1750 | 35 | 7 |
| | 6 | 28312 | 540 | 440 | 1801 | 32 | 6 |
| | 7 | 26533 | 538 | 462 | 1781 | 27 | 5 |
| | 8 | 32874 | 532 | 458 | 1753 | 31 | 3 |
| | 9 | 28785 | 510 | 454 | 1746 | 26 | 4 |
| | 10 | 25765 | 520 | 469 | 1681 | 23 | 5 |
| Com- | 1 | 20501 | 542 | 440 | 2047 | 155 | 156 |
| parative | 2 | N/A | N/A | N/A | N/A | 70 | N/A |
| Example | 3 | 23879 | 537 | 434 | 1945 | 85 | 75 |
| | 4 | 24595 | 519 | 443 | 1935 | 80 | 57 |
| | 5 | 23989 | 527 | 424 | 1928 | 75 | 55 |

In general, commercial applications have specific requirements on the mechanical properties of packaging materials, including tensile modulus of not less than 18000 kgf/cm², tensile strength of not less than 500 kgf/cm², elongation at break of not less than 400%, and impact strength of not less than 1650 g/mm.

In Table 3, it can be seen that the Gloss 60° before stretching of Examples 1-10 are less than or equal to 60 GU. In contrast, the Gloss 60° before stretching of Comparative Examples 1-5 ranges from 70 to 155 GU. Therefore, the Gloss 60° before stretching of Examples 1-10 are lower than that of the Comparative Examples 1-5.

In addition, the Gloss 60° after stretching of Examples 1-10 are no more than 25 GU. In contrast, the Gloss 60° after stretching of Comparative Examples 1-5 ranges from 55 to 156 GU. Therefore, the Gloss 60° after stretching of Examples 1-10 is lower than that of Comparative Examples 1-5. It is noted that the gloss of the low gloss sheet in the present disclosure is significantly reduced after stretching. For example, the gloss of Example 8 decreased from 31 to 3. In contrast, the conventional PET sheet with added particles (such as Comparative Examples 1-5) still not meet the required limitation of low gloss although the gloss of Comparative Examples 1-5 were reduced after stretching. Therefore, the low gloss sheet of the present disclosure has advantages in the application on any related fields that involves stretching and forming techniques, such as application in packaging materials. In particular, the low gloss sheet of the present disclosure remains a low surface gloss after heating and stretching, thereby easing the manufacturing process and having a broad variety of applications.

On the other hand, it is noted that the gloss of Examples 5-10 are lower than that of Examples 1-4. Specifically, the Gloss 60° before stretching of Examples 5-10 is less than or equal to 35 GU, and the Gloss 60° after stretching of Examples 5-10 is no more than 7 GU.

In Table 3, it can be seen that Examples 1-10 also exhibit excellent mechanical properties. The tensile modulus, tensile strength, elongation at break and impact strength of Examples 1-10 are close to or even better than those of Comparative Examples 1-5. The mechanical properties of Comparative Example 2 are poor. It is surmised that because the silicon dioxide powder in Comparative Example 2 tends to aggregation in nature, so that the silicon dioxide powder is poorly dispersed in the low gloss layer, resulting in poor mechanical properties and low-resistant to stretching and impact.

In summary, the low gloss sheet and the matte product prepared therefrom of the present disclosure have a low surface gloss and good mechanical properties. The low gloss surface is maintained even after the low gloss sheet is subjected to heating and stretching processes. Therefore, the low gloss sheet in the present disclosure has a broad variety of applications in the packaging industry and exhibit an exquisite appearance.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A low gloss sheet, comprising:
a substrate; and
a low gloss layer disposed on the substrate, the low gloss layer comprising a polyester and a matting agent having a weight percentage ranged from 4 wt % to 10 wt % in the low gloss layer, wherein the matting agent comprises a plurality of first particles and a plurality of second particles, the first particles have an average particle diameter (d₅₀) of 8 μm to 10 μm, the second particles have an average particle diameter (d₅₀) of 3 μm to 6 μm, and the second particles have an oil absorption ranged from 30 to 100 ml/100 g.

2. The low gloss sheet of claim 1, wherein the first particles have an oil absorption ranged from 10 ml/100 g to 40 ml/100 g.

3. The low gloss sheet of claim 1, wherein the oil absorption of the second particles ranges from 40 ml/100 g to 60 ml/100 g.

4. The low gloss sheet of claim 1, wherein the first particles comprise talcum powder, calcium carbonate powder, or a combination thereof.

5. The low gloss sheet of claim 1, wherein the second particles comprise talcum powder.

6. The low gloss sheet of claim 1, wherein the weight percentage of the matting agent ranges from 7 wt % to 9 wt % based on the total weight of the low gloss layer.

7. The low gloss sheet of claim 1, wherein the second particles have a weight percentage ranged from 1 wt % to 6 wt %, based on the total weight of the low gloss layer.

8. The low gloss sheet of claim 1, wherein the second particles have a weight percentage ranged from 4 wt % to 6 wt %, based on the total weight of the low gloss layer.

9. The low gloss sheet of claim 1, wherein the substrate comprises polyester.

10. The low gloss sheet of claim 1, wherein the low gloss layer has a thickness between 40 μm and 70 μm.

11. The low gloss sheet of claim 1, wherein the low gloss sheet has a gloss that is less than or equal to 65 GU at a measuring angle of 60°.

12. A matte product manufactured from the low gloss sheet of claim 1 by a forming technique.

13. The matte product of claim 12, wherein the matte product has a gloss that is less than or equal to 30 GU at a measuring angle of 60°.
